(19) United States
(12) Patent Application Publication
(10) Pub. No.: US 2013/0091953 A1
(43) Pub. Date: Apr. 18, 2013

(54) AIR IN LINE DETECTOR WITH LOADING ENHANCEMENTS

(71) Applicant: Houston Brown, San Diego, CA (US)

(72) Inventor: Houston Brown, San Diego, CA (US)

(21) Appl. No.: 13/274,949

(22) Filed: Oct. 17, 2011

(51) Int. Cl. H04R 17/00

(52) U.S. Cl. 73/642

(57) ABSTRACT

An ultrasonic air-in-line detector for use with a fluid tube. A housing comprising a first arm and a second arm defines the edges of a cavity. A first convex lens mounted on the first arm protrudes into the cavity from the side of the first arm facing the cavity. A second convex lens mounted on the second arm protrudes into the cavity opposite the first convex lens from the side of the second arm facing the cavity. A first concave section is disposed on the side of the first arm facing the cavity and outside of a signal pathway between the first convex lens and the second convex lens. A second concave section is disposed on the side of the second arm facing the cavity outside of the signal pathway between the first convex lens and the second convex lens.

### BACKGROUND

Intravenous (IV) drug delivery systems are widely used to deliver medicine, blood products, and the like to patients. Typically, a bag of fluids is suspended from a pole and is connected to a fluid pump via an IV tube. The IV tube is then inserted into the patient. It is important to monitor the flow of fluids via the IV drug delivery system to ensure whether fluids are in fact being delivered to the patient, or the bag is empty. Furthermore, it is important to ensure that air is not introduced into the IV line beyond a predetermined amount to prevent the introduction of a potentially fatal air embolism into the patient.

### BRIEF DESCRIPTION OF THE DRAWINGS

The accompanying drawings, which are incorporated in and form a part of this application, illustrate embodiments of the subject matter, and together with the description of embodiments, serve to explain the principles of the embodiments of the subject matter. Unless noted, the drawings referred to in this brief description of drawings should be understood as not being drawn to scale.

FIG. 1 shows a front elevation view of an intravenous (IV) drug delivery system, according to an embodiment.

FIG. 2A is a perspective view of an air-in-line detector, in accordance with an embodiment.

FIG. 2B is a perspective view of an air-in-line detector, in accordance with an embodiment.

FIG. 3 is a cross sectional view of an air-in-line detector seen along line 3-3 of FIG. 2A, in accordance with an embodiment.

FIG. 4 is a is a cross sectional view of an air-in-line detector as shown in FIG. 3 with a fluid tube mounted thereon and restrained therein, in accordance with an embodiment.

FIG. 5 is a block diagram of electronic components of an air-in-line detection system, in accordance with an embodiment.

FIG. 6 is a cross sectional view of a concave section of an arm of an air-in-line detector housing, in accordance with an embodiment.

### DESCRIPTION OF EMBODIMENTS

Reference will now be made in detail to various embodiments, examples of which are illustrated in the accompanying drawings. While the subject matter will be described in conjunction with these embodiments, it will be understood that they are not intended to limit the subject matter to these embodiments. On the contrary, the subject matter described herein is intended to cover alternatives, modifications and equivalents, which may be included within the spirit and scope. Furthermore, in the following description, numerous specific details are set forth in order to provide a thorough understanding of the subject matter. However, some embodiments may be practiced without these specific details. In other instances, well-known structures and components have not been described in detail as not to unnecessarily obscure aspects of the subject matter.

### Overview of Discussion

Herein, various embodiments of an air-in-line detector with loading enhancements are described. The description will begin first with a discussion of an intravenous drug delivery system. Attention will then be directed to an air-in-line detector with loading enhancements in accordance with various embodiments.

### Intravenous Drug Delivery System

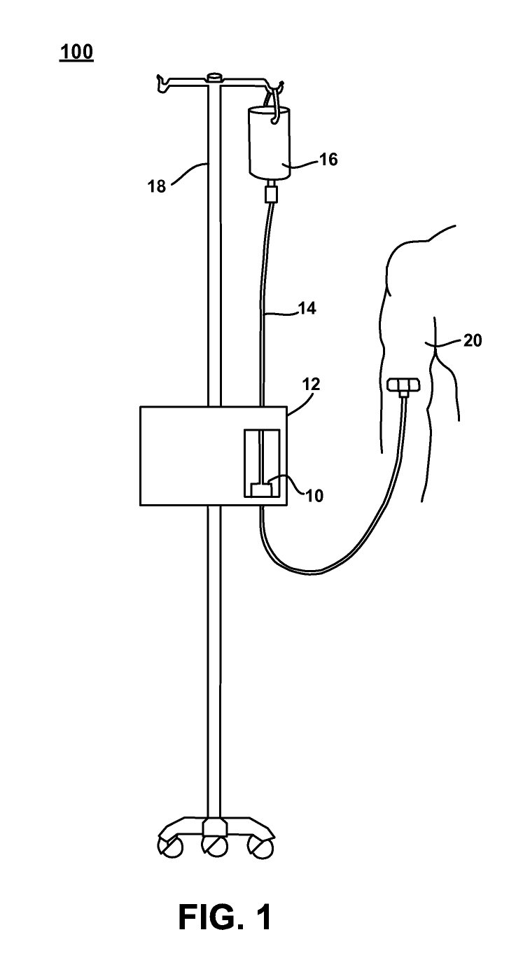

FIG. 1 shows a front elevation view of an intravenous (IV) drug delivery system 100, according to an embodiment. In the embodiment of FIG. 1, IV drug delivery system 100 comprises an air-in-line detector 10 which is coupled with an infusion pump 12. It is noted that while the present embodiment describes an air-in-line detector which is used in an IV drug delivery system, embodiments of the present technology can be used in other applications for detecting the presence of air in a fluid delivery system. In FIG. 1, infusion pump 12 is coupled with an IV tube 14 which delivers fluids, such as medications, blood products, or the like, from a fluid source 16 to a patient 20. As shown in FIG. 1, IV drug delivery system 100 typically suspends fluid source 16 from an IV pole 18.

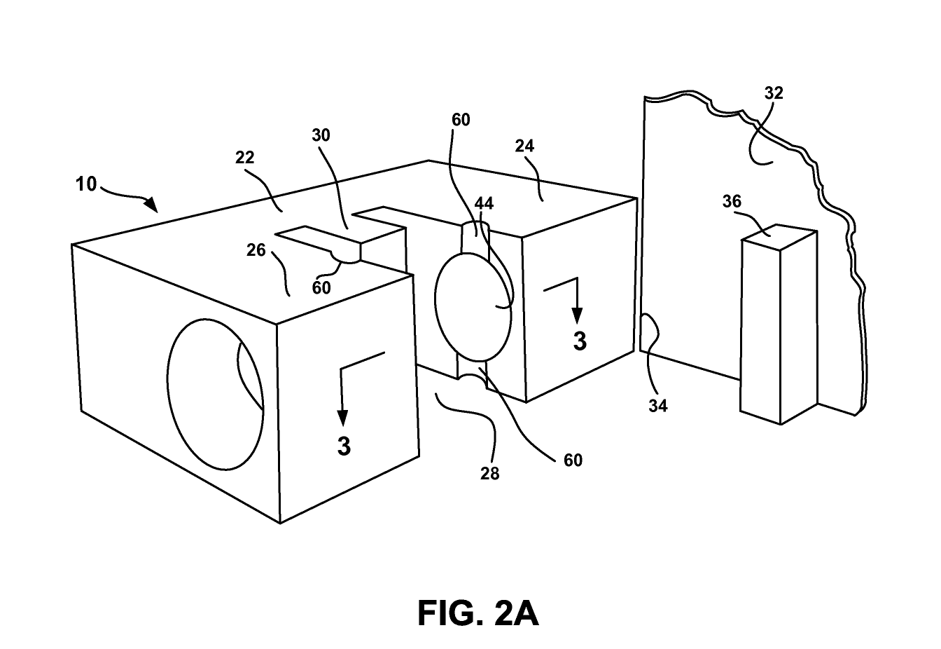

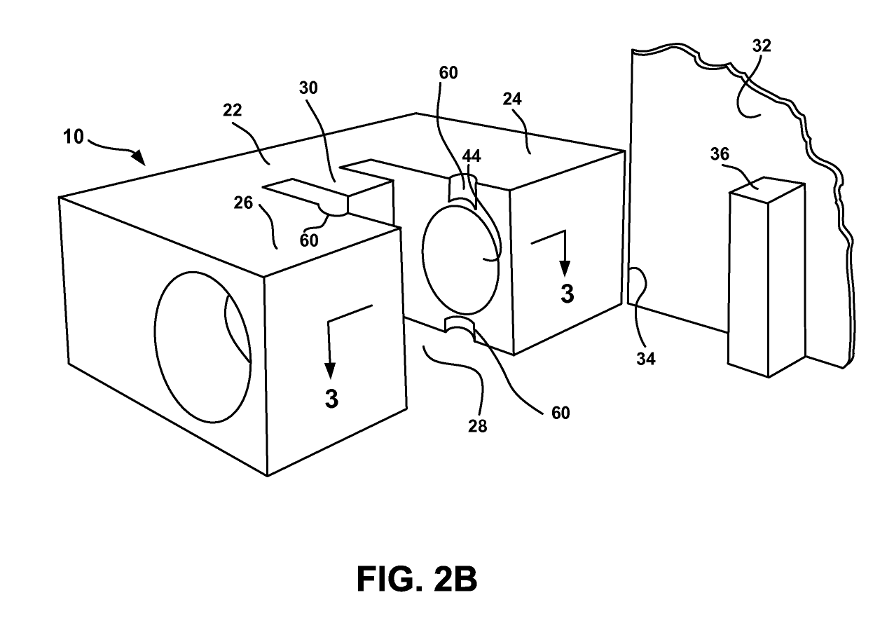

FIG. 2A is a perspective view of an air-in-line detector 10, in accordance with an embodiment. In FIG. 2A, air-in-line detector 10 has a substantially U-shaped housing 22 comprising two oppositely extending arms 24 and 26. A pedestal 30 extends from housing 22 into a cavity 28 which is formed in the area disposed between arms 24 and 26. In accordance with various embodiments, housing 22, arms 24 and 26, and pedestal 30 can be manufactured as a single unit, or as an assembly of a plurality of components. In FIG. 2A, a door 32 is coupled with housing 22 via a hinge 34. It is noted that various embodiments do not require that door 32 be directly coupled with housing 22. For example, door 32 may be coupled with infusion pump 12 via hinge 34. In another embodiment, door 32 may snap into place onto housing 22 or infusion pump 12 using, for example, tabs on door 32 which fit into slots disposed in housing 22 or infusion pump 12. A second pedestal 36 is disposed upon door 32. In accordance with various embodiments, when door 32 is moved into a closed position with housing 22, pedestal 36 also protrudes into cavity 28 between arms 24 and 26. Again, door 32 and pedestal 36 can be manufactured as a single unit, or as an assembly of a plurality of components in accordance with various embodiments.

Also shown in FIG. 2A is a convex acoustic lens 44 disposed upon arm 24 which protrudes into cavity 28. It is appreciated that in one embodiment, a similar convex acoustic lens (not shown) is similarly disposed upon arm 26. In the embodiment of FIG. 2A, a concave section 60 is disposed upon arm 24 in a region adjacent to convex acoustic lens 44. A second concave section 60 is disposed upon arm 26 in a region adjacent to the convex acoustic lens disposed upon arm 26. In one embodiment, concave sections 60 are aligned with the convex acoustic lenses (e.g., 44 of FIG. 2A) such that the center axes of the concave sections 60 are aligned with the center of the convex acoustic lenses. Furthermore, the axis of concave sections 60 is aligned with, and in some embodiments defines, the axis of IV tube 14 when IV tube 14 is placed into cavity 28 and door 32 is placed in a closed position. As will be discussed in greater detail below, the portion of cavity 28 between convex acoustic lenses 44 and 50 comprises an acoustic path through which a signal (e.g., an ultrasonic signal) is passed to detect the presence of air bubbles within IV tube 14. In accordance with various embodiments, when IV tube 14 is located within concave sections 60, its axis is located or positioned such that IV tube 14 is disposed within the signal path between convex acoustic lenses 44 and 50. In accordance with various embodiments, this positioning of IV tube 14 within the signal path between convex acoustic lenses 44 and 50 can be accomplished without the need for a user to hold IV tube 14 in place while closing door 32. In other words, a user can place IV tube 14 within concave sections 60 and release it without concern that IV tube 14 will displace itself outside of the signal path between convex acoustic lenses 44 and 50. As shown in FIG. 2A, concave section 60 extends to the edge of convex acoustic lens 44. Furthermore, it is noted that concave section 60 is disposed upon both sides of convex acoustic lens 44 along an anticipated routing of IV tube 14 when it is inserted into air-in-line detector 10.

FIG. 2B is a perspective view of an air-in-line detector, in accordance with an embodiment. For the purpose of brevity, the components described above with reference to FIG. 2A which are common to the embodiment shown in FIG. 2B will not be described again. In FIG. 2B, concave section(s) 60 are again disposed upon arms 24 and 26. In the embodiment of FIG. 2B, concave section(s) 60 do not extend all the way to the edge of the convex acoustic lenses (e.g., 44 in FIG. 2B). Instead, concave sections 60 are proximate to, but do not extend to, the convex acoustic lenses. Again, in the embodiment of FIG. 2B concave sections 60 are aligned with the convex acoustic lenses (e.g., 44 of FIG. 2A) such that the center axes of concave sections 60 are aligned with the center of the convex acoustic lenses. Additionally, the axis of concave sections 60 is aligned with, and in some embodiments defines, the axis of IV tube 14 when IV tube 14 is placed into cavity 28 and door 32 is placed in a closed position.

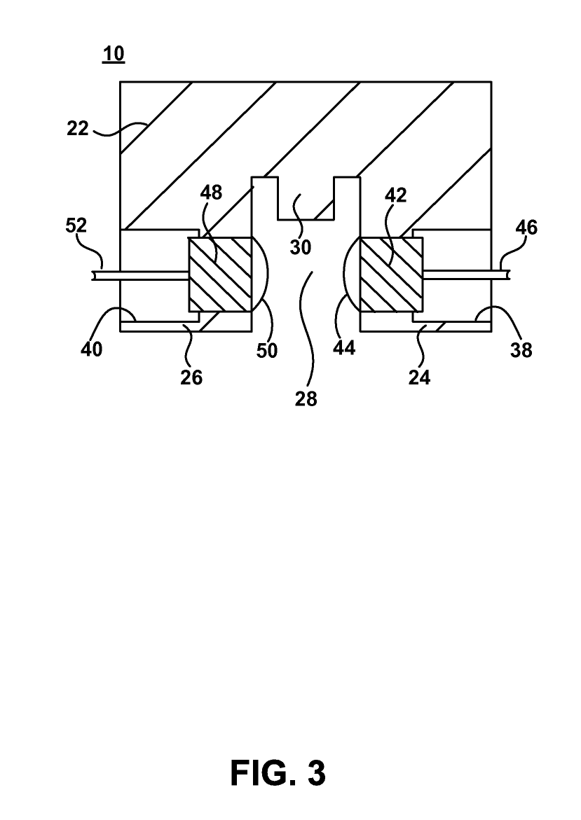

FIG. 3 is a cross sectional view of an air-in-line detector 10 seen along line 3-3 of FIG. 2A, in accordance with an embodiment. In FIG. 3, arm 24 of air-in-line detector 10 has an opening 38 and arm 26 has an opening 40. In one embodiment, piezo-electric crystals 42 and 48 are mounted in openings 38 and 40 respectively. Also shown in FIG. 3, convex acoustic lenses 44 and 50 are respectively disposed between the piezo-electric crystals (e.g., 42 and 48) and cavity 28. In various embodiments, convex acoustic lenses 44 and 50 are spherical convex lenses made of an epoxy material and can be attached to piezo-electric crystals 42 and 48 using, for example, an epoxy adhesive. In another embodiment, convex acoustic lenses 44 and 50 are made of a clear acrylic or other transparent material for use in optical air-in-line systems. Wiring 46 and 52 couple piezo-electric crystals 42 and 48 respectively with other components of an air-in-line detection system. In another embodiment, convex acoustic lenses 44 and 50 are integrally molded into housing 22.

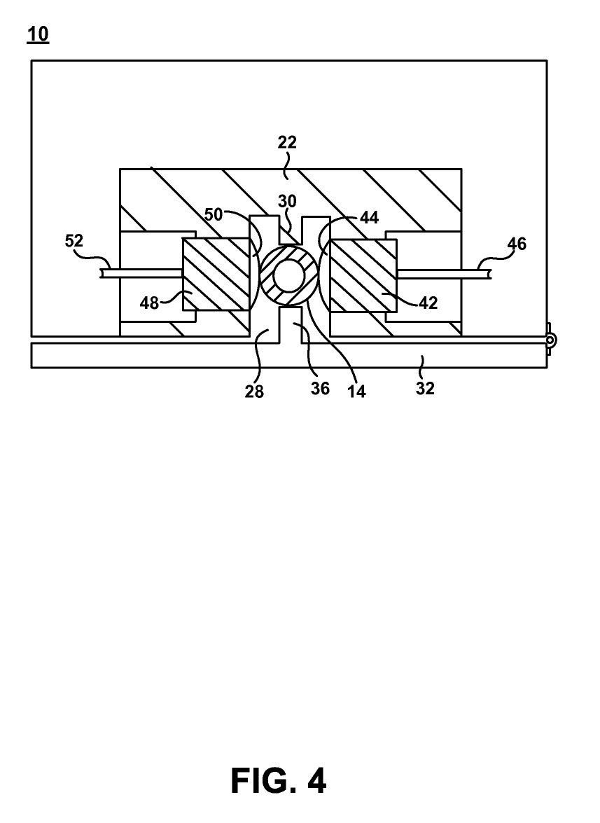

FIG. 4 is a is a cross sectional view of an air-in-line detector 10 as shown in FIG. 3 with a fluid tube mounted thereon and restrained therein, in accordance with an embodiment. In FIG. 4, an IV tube 14 has been placed in cavity 28 and door 32 has been closed. As shown in FIG. 4, when door 32 is closed, IV tube 14 is positioned to remain in contact with pedestal 30 of housing 22 and with pedestal 36 of door 32. In general, pedestals 30 and 36 facilitate positioning IV tube 14 between convex acoustic lenses 44 and 50. In one embodiment, the distance between pedestal 30 and pedestal is selected to slightly pinch IV tube 14 when door 32 is placed in a closed position. Thus, prior knowledge of the size of IV tube 14 can be used to better fit IV tube within cavity 28.

In one embodiment, air-in-line detector 10 uses an ultrasonic air-in-line detection system. As an example, an ultrasonic air-in-line detection system passes ultrasonic energy (e.g., in the megahertz range) through IV tube 14 and the fluid being conveyed through IV tube 14. Detection of air in IV tube 14 is based upon the knowledge that ultrasonic energy does not pass through air as fast as it passes through a solid or liquid medium. In other words, the ultrasonic energy passes through a soli medium such as IV tube 14, and fluid within IV tube 14, at a different speed than when it passes through air. Thus, when there is air in IV tube 14, the ultrasonic energy disperses. In one embodiment, piezo-electric crystal 42 is an ultrasonic transponder which transmits ultrasonic energy through IV tube 14. Piezo-electric crystal 48 acts as an ultrasonic receiver which is configured to measure how much ultrasonic energy from piezo-electric crystal 42 is passing through IV tube 14. This configuration is also known as a “pass through” design. In another embodiment, the transponder component and the receiver component are disposed on the same side of cavity 28 in what is known as a “reflection” design.

In accordance with various embodiments, the distance between convex acoustic lenses 44 and 50 is selected to slightly pinch IV tube 14 when it is properly positioned between convex acoustic lenses 44 and 50. It is noted that the distance between convex acoustic lenses 44 and 50 can be selected based upon the size of IV tube 14. By slightly pinching IV tube 14 when it is positioned between convex acoustic lenses 44 and 50, a better coupling between the convex acoustic lenses and IV tube 14 is realized. This improves the sensitivity of air-in-line detector 10 by eliminating an air gap that may occur between convex acoustic lenses 44 and 50 and IV tube 14. In some systems the existence of an air gap between an IV tube and sensor components (e.g., convex acoustic lenses 44 and 50) can result in a false air-in-line alarm. Thus, in FIG. 4 IV tube 14 is shown as being slightly oblong due to the constraint caused by convex acoustic lenses 44 and 50 rather than a more normally round shape. It is noted that while the present embodiment is described in conjunction with an ultrasonic air-in-line detection system, embodiments of the present technology are not limited to these systems alone and can use, for example, an optical air-in-line detection system.

As described above, IV tube 14 becomes pinched between convex acoustic lenses 44 and 50, as well as pedestals 30 and 36, to eliminate air gaps between IV tube 14 and the lenses. However, this can make proper placement of IV tube 14 within cavity 28 more difficult. For example, due to the pressure upon IV tube 14 when constrained between convex acoustic lenses 44 and 50, IV tube 14 will frequently move to a position within cavity 28 which relieves the pressure upon it. In other words, convex acoustic lenses 44 and 50 provide an unstable mechanical stabilization of IV tube 14 when it is inserted into cavity 28. As a result, IV tube 14 will tend to move toward open corners between convex acoustic lens 50, pedestal 30, convex acoustic lens 44, and pedestal 36 to minimize pressure exerted upon it. This often results in a less than optimal positioning of IV tube 14 between convex acoustic lenses 44 and 50 which can lead to false air-in-line alarms being generated. Because of this, operators of IV drug delivery system 100 must be careful when placing IV tube 14 within cavity 28 to minimize the possibility of its becoming incorrectly positioned.

In accordance with various embodiments, concave sections 60 act to stabilize IV tube 14 in a position which optimizes contact with convex acoustic lenses 44 and 50. Concave sections 60 act to reduce the pressure exerted upon IV tube 14 in the regions of cavity 28 which are outside of the transducer acoustic path. Referring again to FIGS. 2A and 2B, concave sections 60 act as guides which defines the alignment and location of IV tube 14 above and below cavity 28. As can be seen in FIGS. 2A and 2B, concave sections 60 are disposed outside of the acoustic path which is substantially the portion of cavity 28 lying between convex acoustic lenses 44 and 50. By reducing the pressure exerted upon IV tube 14, concave sections 60 increase the likelihood that IV tube 14 will align itself within these concave sections. In so doing, IV tube 14 is also more likely to be correctly aligned within the acoustic path between convex acoustic lenses 44 and 50, especially in conjunction with pedestals 30 and 36, due to its alignment with the concave sections 60 lying above and below the acoustic path. In other words, IV tube 14 is more likely to be correctly aligned in the acoustic path because it is more likely to be aligned with concave sections immediately above and below the acoustic path. Furthermore, concave sections 60 facilitate loading IV tube 14 into air-in-line detector 10 because it is not as likely to pop out of position prior to closing door 32. Current systems rely upon a technician manually attempting to hold IV tube 14 in an optimal position within the acoustic path while simultaneously closing door 32. This can result in IV tube 14 slipping out of the acoustic path and introducing an air gap between IV tube 14 and convex acoustic lenses 44 and 50. It is noted that while the size of concave sections 60 can be selected based upon an anticipated size of IV tube 14. However, it is noted that such selection of the size of concave sections 60 is not required. For example, if the size of concave sections 60 is smaller than the diameter of IV tube 14, the edges where concave sections 60 meet the faces of arms 24 and 26 will contact IV tube 14. This provides a “grip” or “bite” on IV tube 14 which is sufficient for stabilizing its alignment within air-in-line detector 10.

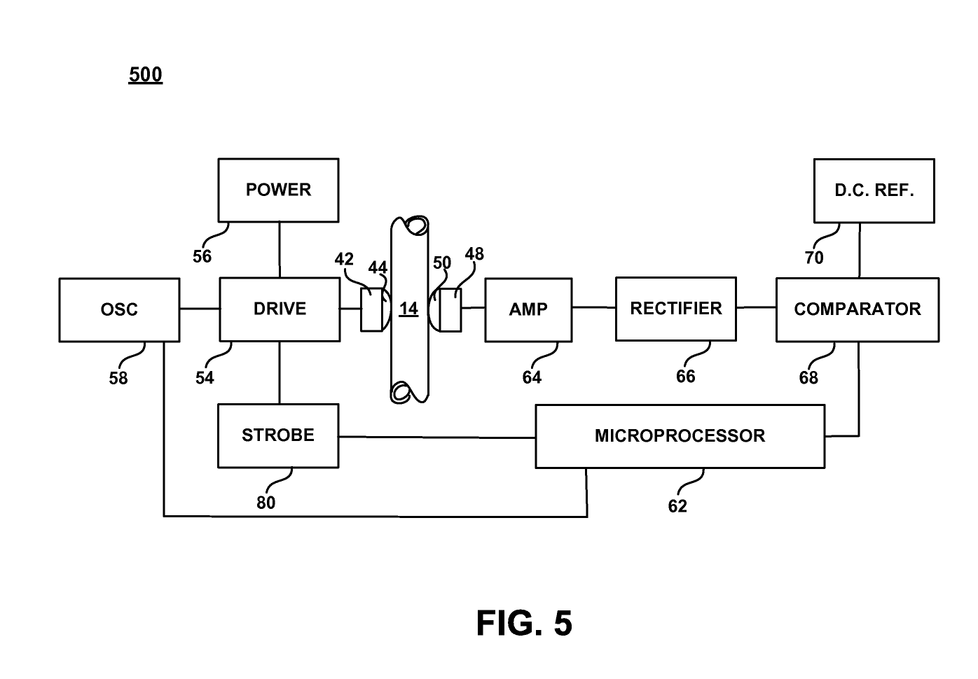

FIG. 5 is a block diagram of electronic components 500 of an air-in-line detection system, in accordance with an embodiment. In FIG. 5, IV tube 14 is placed in operative engagement with piezo-electric crystals 42 and 48 through the mechanical coupling of convex acoustic lenses 44 and 50. In one embodiment, piezo-electric crystal 42 acts as an ultrasonic transmitter which generates ultrasound energy based upon input from drive 54. In one embodiment, the output of drive 54, which is input for piezo-electric crystal 42, is a step signal generated by the interconnection at drive 54 of power source 56 with oscillator 58 and strobe 80. In one embodiment, power source 56 provides electrical power for the system while oscillator 58 causes drive 54 to generate a sinusoidal output at the resonant frequency of crystal 42. Simultaneously, strobe 80 causes drive 54 to turn on or off at predetermined intervals. The result is a step input to crystal 42 that alternated between and off condition, wherein there is no excitation of crystal 42, and an on condition wherein crystal 42 is excited at its resonant frequency to generate ultrasound energy. In one embodiment, strobe 80 is operated by microprocessor 62 to cause switching between the on and off condition approximately every nine milliseconds. In such a case, drive 54 generates a stepped output having an eighteen millisecond cycle. In one embodiment, oscillator 58 operates at a fixed frequency. Alternatively, oscillator can be a swept oscillator which operates at a variety of frequencies which can be controlled using microprocessor 62.

On the receiver side of air-in-line detector 10, piezo-electric crystal 48 is mechanically coupled with IV tube 14 through convex acoustic lens 50 to receive ultrasonic signals generated by piezo-electric crystal 42. In one embodiment, piezo-electric crystal 48 is electrically coupled with amplifier 64 and the output from amplifier 64 is fed to filter/rectifier 66. At filter/rectifier 66, this output is substantially changed from a sinusoidal signal to an amplitude modulated signal. The comparator 68 then takes the output from filter/rectifier 66 and compares it with a d.c. reference voltage from d.c. reference 70 to establish a digital output from comparator 68 which is passed to microprocessor 62.

In one embodiment, microprocessor 62 is configured to analyze the digital output from comparator 68 to determine whether infusion pump 12 is safely operating (e.g., without air in IV tube 14). In one embodiment, this determination is made according to an algorithm which accounts for the rte of fluid flow through IV tube 14 in its analysis in order to ignore very small air bubbles (e.g., bubbles less than approximately fifty microliters) which may not cause serious medical concern. Additionally, microprocessor 62 provides input to strobe 80 to regulate its operation. Also, as discussed above, microprocessor 62 provides a control signal for controlling the frequency of oscillator 58. Microprocessor 62 is configured to analyze the output from air-in-line detector 10 coming from comparator 68 in relation with the input to air-in-line detector 10 beginning at strobe 80.

In operation, air-in-line detector 10 is activated by power from power source 56. IV tube 14 is inserted into cavity 28 and is aligned with concave sections 60. When aligned with concave sections 60, the portion of IV tube 14 will be substantially located within the acoustic path defined between convex acoustic lenses 44 and 50. Upon door 32 being closed, pedestals 30 and 36 further stabilize IV tube 14 within the acoustic path in a manner which minimizes air gaps between IV tube 14 and convex acoustic lenses 44 and 50. Upon initiation of infusion pump 12, fluid flow through IV tube 14 begins and monitoring for air-in-line conditions by microprocessor 62 begins. In accordance with various embodiments, upon detecting an air-in-line condition, air-in-line detector 10 can generate a signal which initiates automatically shutting-off infusion pump 12 to reduce the likelihood of introducing an air embolism. Furthermore, air-in-line detector 12 can generate a signal which initiates sounding an alarm in the room in which infusion pump 12 is located and/or at a remote location such as at a nurse's station.

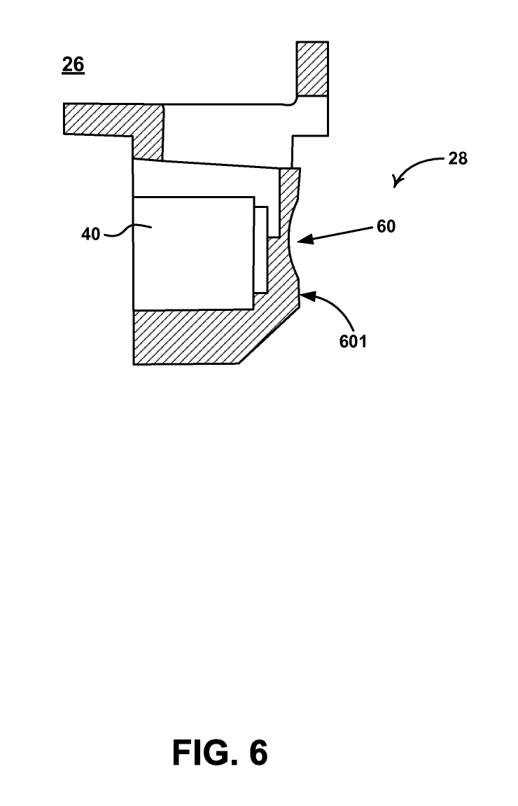

FIG. 6 is a cross sectional view of a concave section 60 of an arm of an air-in-line detector housing 22, in accordance with an embodiment. For the purposes of discussion, a cross sectional view of arm 26 is described. It is noted that a similar mirror-image configuration of arm 24 is understood in accordance with various embodiments. In FIG. 6, side 601 represents the side of arm 26 which is facing cavity 28. Concave section 60 is disposed on side 601 and thus faces cavity 28. In one embodiment, the diameter of concave section 60 is 0.070 inches and is offset from the surface of arm 26 such that the depth of concave section 60 is in a range between 0.008 and 0.011 inches. In one embodiment, opening 40 is for locating piezo-electric crystal 48 as described above.

The foregoing descriptions of specific embodiments have been presented for purposes of illustration and description. They are not intended to be exhaustive or to limit the presented technology to the precise forms disclosed, and obviously many modifications and variations are possible in light of the above teaching. The figures and embodiments were chosen and described in order to best explain the principles of the presented technology and its practical application, to thereby enable others skilled in the art to best utilize the presented technology and various embodiments with various modifications as are suited to the particular use contemplated. While the subject matter has been described in particular embodiments, it should be appreciated that the subject matter should not be construed as limited by such embodiments, but rather construed according to the following claims.

What is claimed is:

1. An ultrasonic air-in-line detector for use with a fluid tube, said ultrasonic air-in-line detector comprising:
a housing comprising a first arm and a second arm which define edges of a cavity;
a first convex lens mounted on said first arm and protruding into said cavity from the side of said first arm facing said cavity;
a second convex lens mounted on said second arm and protruding into said cavity opposite said first convex lens from the side of said second arm facing said cavity;
a first concave section disposed on the side of said first arm facing said cavity, said first concave section disposed outside of a signal pathway between said first convex lens and said second convex lens; and
a second concave section disposed on the side of said second arm facing said cavity, said second concave section disposed outside of said signal pathway between said first convex lens and said second convex lens.

2. The detector recited in claim 1 further comprising:
a third concave section disposed on the side of said first arm facing said cavity and on the opposite side of said first convex lens from said first concave section disposed on said first arm; and
a fourth concave section disposed on the side of said second arm facing said cavity and on the opposite side of said second convex lens from said second concave section disposed on said second arm.

3. The detector recited in claim 1 further comprising:
a first pedestal disposed on said housing and protruding into said cavity in a direction substantially at right angles to the axis defined between said first convex lens and said second convex lens; and
a door attached to said housing and comprising a second pedestal for movement into contact with said tube diametrically opposite said first pedestal when said door is moved to a closed position.

4. The detector recited in claim 1 wherein said door is attached to said housing via a hinge.

5. The detector recited in claim 3 wherein said fluid tube is pinchingly engaged between said first convex lens and said second convex lens when inserted into said cavity and wherein said fluid tube is further pinchingly engaged between said first pedestal and said second pedestal when said door is moved to a closed position.

6. The detector recited in claim 1 further comprising:
a transmitter disposed beneath said first convex lens comprising a piezo-electric crystal and wherein said transmitter is attached to said first convex lens by an epoxy adhesive; and
a receiver disposed beneath said second convex lens comprising a piezo-electric crystal and wherein said receiver is attached to said second convex lens by an epoxy adhesive.

7. The detector recited in claim 1 wherein said first convex lens and said second convex lens are spherical convex lenses.

8. The detector recited in claim 1 wherein said first convex lens and said second convex lens are integrally formed on said housing.

9. An ultrasonic device for detecting air in a flexible fluid tube having a predetermined outside diameter, said ultrasonic device comprising:
a housing comprising a first arm and a second arm which define edges of a cavity;
a transmitter having a first convex lens and mounted on said first arm and protruding into said cavity from the side of said first arm facing said cavity;
a receiver having a second convex lens and mounted on said second arm and protruding into said cavity opposite said first convex lens from the side of said second arm facing said cavity and forming a gap therebetween, said gap being of lesser dimension than the outside diameter of said fluid tube to receive said tube in said gap and pinchingly indent said fluid tube between said transmitter and with said receiver to acoustically couple said tube therebetween;
a first concave section disposed on the side of said first arm facing said cavity, said first concave section disposed outside of a signal pathway between said first convex lens and said second convex lens; and
a second concave section disposed on the side of said second arm facing said cavity, said second concave section disposed outside of said signal pathway between said first convex lens and said second convex lens.

10. The device recited in claim 9 further comprising:
a first pedestal mounted on said housing and protruding into said gap in a direction substantially at right angles to the axis defined between said transmitter and said receiver; and
a second pedestal attached to a door for movement into contact with said tube diametrically opposite said first pedestal to pinchingly engage said tube between said first pedestal and said second pedestal.

11. The device recited in claim 10 wherein said lenses are made of an epoxy material and said transmitter and said receiver respectively comprise piezo-ceramic crystals to which said lenses are attached by an epoxy adhesive.

12. The device recited in claim 11 wherein said door is attached to said housing via a hinge.

13. The device recited in claim 9 further comprising:
a third concave section disposed on the side of said first arm facing said cavity and on the opposite side of said first convex lens from said first concave section disposed on said first arm; and
a fourth concave section disposed on the side of said second arm facing said cavity and on the opposite side of said second convex lens from said second concave section disposed on said second arm.

14. The device recited in claim 13 further comprising means to create an alarm when said output from said receiver does not track with said input to said transmitter.

15. The device recited in claim 14 wherein said lens for said transmitter and said lens for said receiver are spherical convex lenses.

16. The device recited in claim 10 wherein said lenses are integrally formed on said housing.

17. An ultrasonic air-in-line detector for use with a fluid tube which comprising a housing formed with a cavity, a transmitter having a first convex lens mounted on a first arm of said housing with said lens protruding into said cavity to contact and indent said fluid tube, and a receiver having a second convex lens mounted on a second arm of said housing with said lens protruding into said cavity to contact and indent said fluid tube to pinchingly engage said fluid tube between said transmitter and said receiver, a first pedestal disposed on said housing and protruding into said cavity in a direction substantially at right angles to an axis defined between said first convex lens and said second convex lens, a door attached to said housing and comprising a second pedestal for movement into contact with said fluid tube diametrically opposite said first pedestal when said door is moved to a closed position, said ultrasonic air-in-line detector further comprising:
a first concave section disposed on the side of said first arm facing said cavity, said first concave section disposed outside of a signal pathway between said first convex lens and said second convex lens; and
a second concave section disposed on the side of said second arm facing said cavity, said second concave section disposed outside of said signal pathway between said first convex lens and said second convex lens, said first concave section and said second concave section configured to define an axis of alignment of said fluid tube when disposed within said cavity.

18. The ultrasonic air-in-line detector recited in claim 17 further comprising:
a third concave section disposed on the side of said first arm facing said cavity and on the opposite side of said first convex lens from said first concave section disposed on said first arm; and
a fourth concave section disposed on the side of said second arm facing said cavity and on the opposite side of said second convex lens from said second concave section disposed on said second arm.

19. The ultrasonic air-in-line detector recited in claim 17 wherein said fluid tube is pinchingly engaged between said first pedestal and said second pedestal when said door is moved to a closed position.

20. The ultrasonic air-in-line detector recited in claim 17 further comprising:
a transmitter disposed beneath said first convex lens comprising a piezo-electric crystal and wherein said transmitter is attached to said first convex lens by an epoxy adhesive; and
a receiver disposed beneath said second convex lens comprising a piezo-electric crystal and wherein said receiver is attached to said second convex lens by an epoxy adhesive.
